(19) United States
(12) Patent Application Publication
(10) Pub. No.: US 2022/0297599 A1
(43) Pub. Date: Sep. 22, 2022

(54) DRIVING SUPPORT DEVICE, DRIVING SUPPORT METHOD, AND STORAGE MEDIUM

(71) Applicant: HONDA MOTOR CO., LTD., Tokyo (JP)

(72) Inventors: Yugo Kajiwara, Wako-shi (JP); Kazuma Hamada, Wako-shi (JP); Takuma Kobayashi, Wako-shi (JP)

(21) Appl. No.: 17/679,145

(22) Filed: Feb. 24, 2022

(30) Foreign Application Priority Data
Mar. 17, 2021 (JP) 2021-043225

(51) Int. Cl. B60Q 9/00

(52) U.S. Cl. CPC B60Q 9/00

(57) ABSTRACT

A driving support device includes: a situation information acquiring unit configured to acquire situation information of a vehicle; a posture detecting unit configured to detect a posture of a driver of the vehicle; and an alarm processing unit configured to perform an alarm process of outputting information from an alarm device. The alarm processing unit is configured to perform the alarm process when the detected posture matches one posture of a first posture group and to withhold execution of the alarm process on the basis of an occurrence frequency of a predetermined event indicating that the alarm process is not valid when a situation indicated by the situation information matches a specific situation and the detected posture matches one posture of a second posture group included in the first posture group.

### CROSS-REFERENCE TO RELATED APPLICATION

Priority is claimed on Japanese Patent Application No. 2021-043225, filed Mar. 17, 2021, the content of which is incorporated herein by reference.

### BACKGROUND OF THE INVENTION

### Field of the Invention

The present invention relates to a driving support device, a driving support method, and a storage medium.

### Description of Related Art

A system that handles an abnormality that happens to a driver of a vehicle (hereinafter referred to as an “abnormality handling system”) is known. An abnormality that happens to a driver of a vehicle is, for example, an abnormality in which the driver does not wake up. The abnormality handling system detects posture destabilization of a driver to detect whether the driver is awake. An abnormality handling system disclosed in Published Japanese Translation No. 2019-507443 of the PCT International Publication detects an abnormality that happens to a driver of a vehicle on the basis of an inclination of the driver's head. The abnormality handling system may perform an alarm process based on posture destabilization of the driver. In the alarm process, for example, a hazard lamp of the vehicle flickers and an alarm is output from the vehicle.

### SUMMARY OF THE INVENTION

However, when posture destabilization occurs due to posture peculiarity of the driver, the alarm process is performed even though the driver is awake and thus the driver may feel discomfort from the alarm process. In this way, the alarm process based on posture destabilization of the driver of the vehicle may not be able to be performed at an appropriate timing.

An aspect of the present invention was invented in consideration of the aforementioned circumstances and an objective thereof is to provide a driving support device, a driving support method, and a storage medium that can perform an alarm process based on posture destabilization of a driver of a vehicle at an appropriate timing.

In order to solve the aforementioned problems and to achieve the aforementioned objective, the present invention employs the following aspects.

(1) A driving support device according to an aspect of the present invention includes: a situation information acquiring unit configured to acquire situation information of a vehicle; a posture detecting unit configured to detect a posture of a driver of the vehicle; and an alarm processing unit configured to perform an alarm process of outputting information from an alarm device, wherein the alarm processing unit is configured to perform the alarm process when the detected posture matches one posture of a first posture group and to withhold execution of the alarm process on the basis of an occurrence frequency of a predetermined event indicating that the alarm process is not valid when a situation indicated by the situation information matches a specific situation and the detected posture matches one posture of a second posture group included in the first posture group.

(2) In the aspect of (1), the specific situation may be a situation in which a speed of the vehicle is less than a reference speed, a traffic volume near the vehicle is less than a reference volume, and a shape of a road on which the vehicle travels is not a crossing.

(3) In the aspect of (1) or (2), the alarm processing unit may be configured to derive the number of times the alarm process has been cancelled by the driver as an occurrence frequency of the predetermined event.

(4) In the aspect of (3), the alarm processing unit may be configured to withhold derivation of the occurrence frequency of the predetermined event when the detected situation does not match the specific situation or when the detected posture does not match any posture of the second posture group.

(5) A driving support method according to another aspect of the present invention is a driving support method that is performed by a computer of a driving support device, the driving support method including: a situation information acquiring step of acquiring situation information of a vehicle; a posture detecting step of detecting a posture of a driver of the vehicle; and an alarm processing step of performing an alarm process of outputting information from an alarm device, wherein the alarm processing step includes performing the alarm process when the detected posture matches one posture of a first posture group and withholding execution of the alarm process on the basis of an occurrence frequency of a predetermined event indicating that the alarm process is not valid when a situation indicated by the situation information matches a specific situation and the detected posture matches one posture of a second posture group included in the first posture group.

(6) A storage medium according to another aspect of the present invention is a non-transitory computer-readable storage medium storing a program, the program causing a computer to perform: a situation information acquiring process of acquiring situation information of a vehicle; a posture detecting process of detecting a posture of a driver of the vehicle; and an alarm processing process of performing an alarm process of outputting information from an alarm device, wherein the alarm processing process includes performing the alarm process when the detected posture matches one posture of a first posture group and withholding execution of the alarm process on the basis of an occurrence frequency of a predetermined event indicating that the alarm process is not valid when a situation indicated by the situation information matches a specific situation and the detected posture matches one posture of a second posture group included in the first posture group.

According to the aspects of (1) to (6), since the driving support device withholds execution of the alarm process on the basis of the occurrence frequency of the predetermined event indicating that the alarm process is not valid when the situation indicated by the situation information matches the specific situation and the detected posture matches one posture of the second posture group included in the first posture group, it is possible to perform the alarm process based on posture destabilization of a driver of the vehicle at an appropriate timing.

### BRIEF DESCRIPTION OF THE DRAWINGS

FIG. 1 is a diagram illustrating an example of a configuration of a vehicle system employing a driving support device according to an embodiment.

FIG. 2 is a diagram illustrating an example of functional configurations of a first control unit and a second control unit.

FIG. 3 is a diagram illustrating an example of a functional configuration of a third control unit.

FIG. 4 is a diagram illustrating a first example of posture matching determination.

FIG. 5 is a diagram illustrating a second example of posture matching determination.

FIG. 6 is a diagram illustrating a data table indicating whether execution of an alarm process can be withheld for each combination of a situation and a posture.

FIG. 7 is a flowchart illustrating an example of an operation of the third control unit.

FIG. 8 is a diagram illustrating an example of a hardware configuration of the driving support device according to the embodiment.

### DETAILED DESCRIPTION OF THE INVENTION

Hereinafter, a driving support device, a driving support method, and a storage medium according to an embodiment of the present invention will be described with reference to the accompanying drawings.

Overall Configuration

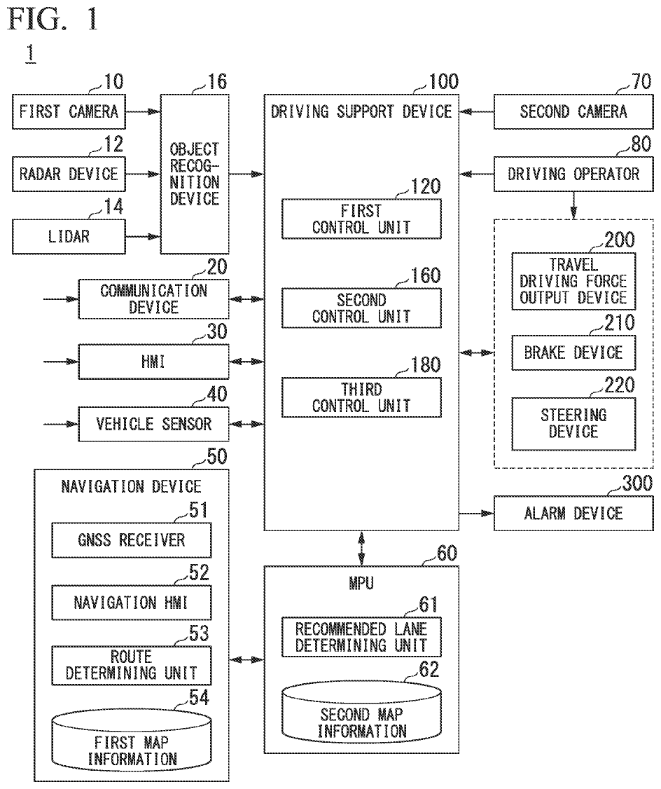

FIG. 1 is a diagram illustrating an example of a configuration of a vehicle system 1 employing a driving support device 100 according to an embodiment. A vehicle in which the vehicle system 1 is mounted is, for example, a vehicle with two wheels, three wheels, or four wheels and a drive source thereof is an internal combustion engine such as a diesel engine or a gasoline engine, an electric motor, or a combination thereof. The electric motor operates using electric power generated by a power generator connected to the internal combustion engine or electric power discharged from a secondary battery or a fuel cell.

The vehicle system 1 includes, for example, a first camera 10, a radar device 12, a Light Detection and Ranging (LIDAR) 14, an object recognition device 16, a communication device 20, a human-machine interface (HMI) 30, a vehicle sensor 40, a navigation device 50, a map positioning unit (MPU) 60, a second camera 70, a driving operator 80, a driving support device 100, a travel driving force output device 200, a brake device 210, a steering device 220, and an alarm device 300. These devices or instruments are connected to each other via a multiplex communication line such as a controller area network (CAN) communication line, a serial communication line, a radio communication network, or the like. The configuration illustrated in FIG. 1 is only an example and a part of the configuration may be omitted or another configuration may be added thereto.

The first camera 10 is, for example, a digital camera using a solid-state imaging device such as a charge coupled device (CCD) or a complementary metal oxide semiconductor (CMOS). The first camera 10 is attached to an arbitrary position on a vehicle in which the vehicle system 1 is mounted (hereinafter referred to as a host vehicle M). When the front view of the host vehicle M is imaged, the first camera 10 is attached to an upper part of a front windshield, a rear surface of a rearview mirror, or the like. The first camera 10 images the surroundings of the host vehicle M, for example, periodically and repeatedly. The first camera 10 may be a stereoscopic camera.

The radar device 12 radiates radio waves such as millimeter waves to the surroundings of the host vehicle M, detects radio waves (reflected waves) reflected by an object, and detects at least a position (a distance and a direction) of the object. The radar device 12 is attached to an arbitrary position on the host vehicle M. The radar device 12 may detect a position and a speed of an object using a frequency modulated continuous wave (FM-CW) method.

The LIDAR 14 radiates light (or electromagnetic waves of wavelengths close to light) to the surroundings of the host vehicle M and measures scattered light. The LIDAR 14 detects a distance to an object on the basis of a time from radiation of light to reception of light. The radiated light is, for example, a pulse-like laser beam. The LIDAR 14 is attached to an arbitrary position on the host vehicle M.

The object recognition device 16 performs a sensor fusion process on results of detection from some or all of the first camera 10, the radar device 12, and the LIDAR 14 and recognizes a position, a type, a speed, and the like of an object. The object recognition device 16 outputs the result of recognition to the driving support device 100. The object recognition device 16 may output the results of detection from the first camera 10, the radar device 12, and the LIDAR 14 to the driving support device 100 without any change. The object recognition device 16 may be omitted from the vehicle system 1.

The communication device 20 communicates with other vehicles near the host vehicle M, for example, using a cellular network, a Wi-Fi network, Bluetooth (registered trademark), or dedicated short range communication (DSRC) or communicates with various server devices via a radio base station.

The HMI 30 presents various types of information to an occupant of the host vehicle M and receives an input operation from the occupant. The HMI 30 includes various display devices, speakers, buzzers, touch panels, switches, and keys.

The vehicle sensor 40 includes a vehicle speed sensor that detects a speed of the host vehicle M, an acceleration sensor that detects an acceleration, a yaw rate sensor that detects an angular velocity around a vertical axis, and a direction sensor that detects a direction of the host vehicle M.

The navigation device 50 includes, for example, a global navigation satellite system (GNSS) receiver 51, a navigation HMI 52, and a route determining unit 53. The navigation device 50 stores first map information 54 in a storage device such as a hard disk drive (HDD) or a flash memory. The GNSS receiver 51 identifies a position of the host vehicle M on the basis of signals received from GNSS satellites. The position of the host vehicle M may be identified or corrected by an inertial navigation system (INS) using the output of the vehicle sensor 40. The navigation HMI 52 includes a display device, a speaker, a touch panel, and keys. A whole or a part of the navigation HMI 52 may be shared by the HMI 30. For example, the route determining unit 53 determines a route (hereinafter, referred to as a “route on a map”) from the position of the host vehicle M identified by the GNSS receiver 51 (or an input arbitrary position) to a destination input by an occupant using the navigation HMI 52 with reference to the first map information 54. The first map information 54 is, for example, information in which a road shape is expressed by links indicating a road and nodes connected by the links. The first map information 54 may include a curvature of a road or point of interest (POI) information. The route on a map is output to the MPU 60. The navigation device 50 may perform route guidance using the navigation HMI 52 on the basis of the route on a map. The navigation device 50 may be realized, for example, by a function of a terminal device such as a smartphone or a tablet terminal which is carried by an occupant. The navigation device 50 may transmit a current position and a destination to a navigation server via the communication device 20 and acquire a route which is equivalent to the route on a map from the navigation server.

The MPU 60 includes, for example, a recommended lane determining unit 61 and stores second map information 62 in a storage device such as an HDD or a flash memory. The recommended lane determining unit 61 divides a route on a map supplied from the navigation device 50 into a plurality of blocks (for example, every 100 [m] in a vehicle travel direction) and determines a recommended lane for each block with reference to the second map information 62. The recommended lane determining unit 61 determines in which lane from the leftmost the host vehicle is to travel. When there is a branching point in the route on a map, the recommended lane determining unit 61 determines a recommended lane such that the host vehicle M can travel along a rational route for traveling to a branching destination.

The second map information 62 is map information with higher precision than the first map information 54. The second map information 62 includes, for example, information on the centers of lanes or information on boundaries of lanes. The second map information 62 may include road information, traffic regulation information, address information (addresses and postal codes), facility information, and phone number information. The second map information 62 may be updated from time to time by causing the communication device 20 to communicate with another device.

The second camera 70 is, for example, a digital camera using a solid-state imaging device such as a CCD or a CMOS. The second camera 70 is attached to an arbitrary position in the host vehicle M. The second camera 70 images a driver, for example, periodically and repeatedly.

The driving operator 80 includes, for example, an accelerator pedal, a brake pedal, a shift lever, a steering wheel, a deformed steering wheel, a joystick, and other operators. A sensor that detects an amount of operation or performing of an operation is attached to the driving operator 80. Results of detection of the sensor are output to the driving support device 100 or some or all of the travel driving force output device 200, the brake device 210, and the steering device 220.

The driving support device 100 includes, for example, a first control unit 120 and a second control unit 160. The first control unit 120 and the second control unit 160 are realized, for example, by causing a hardware processor such as a central processing unit (CPU) to execute a program (software). Some or all of such elements may be realized by hardware (which includes circuitry) such as a large scale integration (LSI), an application-specific integrated circuit (ASIC), or a field-programmable gate array (FPGA), or a graphics processing unit (GPU) or may be realized by software and hardware in cooperation. The program may be stored in a storage device such as an HDD or a flash memory (a storage device including a non-transitory storage medium) of the driving support device 100 in advance, or may be stored in a removable storage medium such as a DVD or a CD-ROM and installed in the HDD or the flash memory of the driving support device 100 by setting the removable storage medium (non-transitory storage medium) in a drive device.

The alarm device 300 causes, for example, a hazard lamp to flicker as an alarm process under the control of a third control unit 180. The alarm device 300 outputs, for example, an alarm as the alarm process under the control of the third control unit 180.

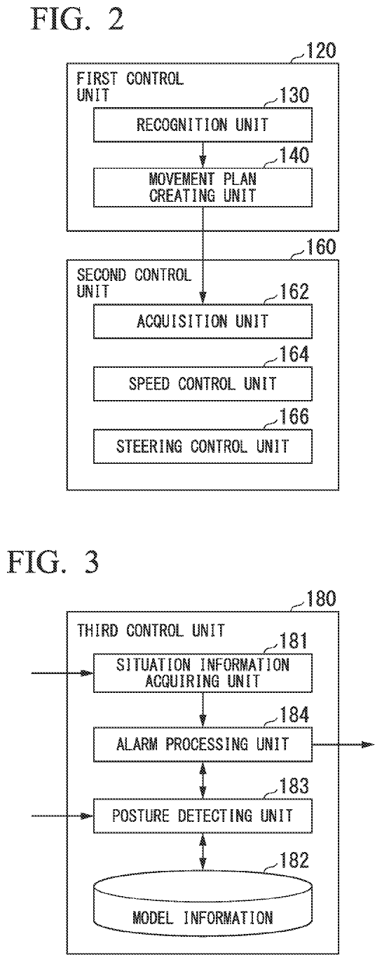

FIG. 2 is a diagram illustrating an example of functional configurations of the first control unit 120 and the second control unit 160. The first control unit 120 includes, for example, a recognition unit 130 and a movement plan creating unit 140. For example, the first control unit 120 realizes a function based on artificial intelligence (AI) and a function based on a predetermined model together. For example, a function of “recognizing a crossing” may be realized by performing recognition of a crossing based on deep learning or the like and recognition based on predetermined conditions (such as signals and road signs which can be pattern-matched) together, scoring both recognitions, and comprehensively evaluating the recognitions. Accordingly, reliability of automated driving is secured.

The recognition unit 130 recognizes states such as a position, a speed, and an acceleration of an object near the host vehicle M on the basis of information input from the first camera 10, the radar device 12, and the LIDAR 14 via the object recognition device 16. For example, a position of an object is recognized as a position in an absolute coordinate system with an origin set to a representative point of the host vehicle M (such as the center of gravity or the center of a drive shaft) and is used for control. A position of an object may be expressed as a representative point such as the center of gravity or a corner of the object or may be expressed as a drawn area. A “state” of an object may include an acceleration or a jerk of the object or a “moving state” (for example, whether lane change is being performed or whether lane change is going to be performed) thereof.

The recognition unit 130 recognizes, for example, a lane (a travel lane) in which the host vehicle M is traveling. For example, the recognition unit 130 recognizes the travel lane by comparing a pattern of lane boundary lines near the host vehicle M recognized from an image captured by the first camera 10 with a pattern of lane boundary lines (for example, arrangement of a solid line and a dotted line) acquired from the second map information 62. The recognition unit 130 is not limited to the lane boundary lines, but may recognize the travel lane by recognizing travel road boundaries (road boundaries) including lane boundary lines, edges of roadsides, curbstones, median strips, and guard rails. In this recognition, the position of the host vehicle M acquired from the navigation device 50 and the result of processing from the INS may be considered. The recognition unit 130 recognizes a stop line, an obstacle, a red signal, a toll gate, or other road events.

The recognition unit 130 recognizes a position or a direction of the host vehicle M with respect to a travel lane at the time of recognition of the travel lane. The recognition unit 130 may recognize, for example, a separation of a reference point of the host vehicle M from the lane center and an angle of the travel direction of the host vehicle M with respect to a line formed by connecting the lane centers in the travel direction of the host vehicle M as the position and the direction of the host vehicle M relative to the travel lane. Instead, the recognition unit 130 may recognize a position of a reference point of the host vehicle M relative to one side line of the travel lane (a lane boundary line or a road boundary) or the like as the position of the host vehicle M relative to the travel lane.

The movement plan creating unit 140 creates a target trajectory in which the host vehicle M will travel autonomously (without requiring a driver's operation) in the future such that the host vehicle M can travel in a recommended lane determined by the recommended lane determining unit 61 and cope with surrounding circumstances of the host vehicle M in principle. A target trajectory includes, for example, a speed element. For example, a target trajectory is expressed by sequentially arranging points (trajectory points) at which the host vehicle M is to arrive. Trajectory points are points at which the host vehicle M is to arrive at intervals of a predetermined traveling distance (for example, about several [m]) along a road, and a target speed and a target acceleration at intervals of a predetermined sampling time (for example, about below the decimal point [sec]) are created as a part of the target trajectory in addition. Trajectory points may be positions at which the host vehicle M is to arrive at sampling times every predetermined sampling time. In this case, information of a target speed or a target acceleration is expressed by intervals between the trajectory points.

The movement plan creating unit 140 may set events of automated driving in creating a target trajectory. The events of automated driving include a constant-speed travel event, a low-speed following travel event, a lane change event, a branching event, a merging event, and an overtaking event. The movement plan creating unit 140 creates a target trajectory based on events which are started.

The second control unit 160 controls the travel driving force output device 200, the brake device 210, and the steering device 220 such that the host vehicle M travels along a target trajectory created by the movement plan creating unit 140 as scheduled.

Referring back to FIG. 2, the second control unit 160 includes, for example, an acquisition unit 162, a speed control unit 164, and a steering control unit 166. The acquisition unit 162 acquires information of a target trajectory (trajectory points) created by the movement plan creating unit 140 and stores the acquired information in a memory (not illustrated). The speed control unit 164 controls the travel driving force output device 200 or the brake device 210 on the basis of a speed element accessory to the target trajectory stored in the memory. The steering control unit 166 controls the steering device 220 on the basis of a curve state of the target trajectory stored in the memory. The processes of the speed control unit 164 and the steering control unit 166 are realized, for example, in combination of feed-forward control and feedback control. For example, the steering control unit 166 performs control in combination of feed-forward control based on a curvature of a road in front of the host vehicle M and feedback control based on a separation from the target trajectory.

The travel driving force output device 200 outputs a travel driving force (a torque) for allowing a vehicle to travel to driving wheels. The travel driving force output device 200 includes, for example, a combination of an internal combustion engine, an electric motor, and a transmission and an electronic control unit (ECU) that controls them. The ECU controls the elements on the basis of information input from the second control unit 160 or information input from the driving operator 80.

The brake device 210 includes, for example, a brake caliper, a cylinder that transmits a hydraulic pressure to the brake caliper, an electric motor that generates a hydraulic pressure in the cylinder, and a brake ECU. The brake ECU controls the electric motor on the basis of the information input from the second control unit 160 or the information input from the driving operator 80 such that a brake torque based on a braking operation is output to vehicle wheels. The brake device 210 may include a mechanism for transmitting a hydraulic pressure generated by an operation of the brake pedal included in the driving operator 80 to the cylinder via a master cylinder as a backup. The brake device 210 is not limited to the above-mentioned configuration, and may be an electronically controlled hydraulic brake device that controls an actuator on the basis of information input from the second control unit 160 such that the hydraulic pressure of the master cylinder is transmitted to the cylinder.

The steering device 220 includes, for example, a steering ECU and an electric motor. The electric motor changes a direction of turning wheels, for example, by applying a force to a rack-and-pinion mechanism. The steering ECU drives the electric motor on the basis of the information input from the second control unit 160 or the information input from the driving operator 80 to change the direction of the turning wheels.

Alarm Process

FIG. 3 is a diagram illustrating an example of a functional configuration of the third control unit 180. The third control unit 180 is a functional unit that performs an alarm process using the alarm device 300. The third control unit 180 includes a situation information acquiring unit 181, model information 182, a posture detecting unit 183, and an alarm processing unit 184.

The functional elements such as the situation information acquiring unit 181, the posture detecting unit 183, and the alarm processing unit 184 are realized, for example, by causing a hardware processor such as a CPU to execute a program (software). Some or all of such elements may be realized by hardware (which includes circuitry) such as an LSI, an ASIC, an FPGA, or a GPU or may be realized by software and hardware in cooperation. The program may be stored in a storage device such as an HDD or a flash memory (a storage device including a non-transitory storage medium) in advance, or may be stored in a removable storage medium such as a DVD or a CD-ROM and installed by setting the removable storage medium (non-transitory storage medium) in a drive device.

The situation information acquiring unit 181 acquires a traffic volume (for example, the number of other vehicles and the number of pedestrians) near the host vehicle and a shape of a road on which the vehicles travel (for example, a straight line, a curve, or a crossing) as vehicle situation information from the object recognition device 16. The situation information acquiring unit 181 acquires speed information of the host vehicle as vehicle situation information from the vehicle sensor 40.

The model information 182 is stored in a storage device in advance. The model information 182 is, for example, a trained model which has been trained (trained under supervision) using training data. The training data includes learning data (explanatory variables) and correct answer data (objective variables). The learning data is an image of a driver. The correct answer data is predetermined posture indices (data on a posture of an imaged driver). Accordingly, the model information 182 (a trained model) outputs a numerical value of a predetermined posture index (hereinafter referred to as a “posture index value”) when an image of a driver is input thereto.

A posture index is, for example, at least one of a position of a driver's head (in a longitudinal direction, a lateral direction, and a vertical direction) and an inclination (a yaw, a pitch, and a roll) of the driver's head. A posture index may be, for example, at least one of a position of an upper half of a driver (in the longitudinal direction, the lateral direction, and the vertical direction) and an inclination (a yaw, a pitch, and a roll) of the upper half of the driver.

The third control unit 180 handles a posture group including shrimp-like bending, backward bending, head side-toppling, side bending, side toppling, forward bending, and prostrating as a first posture group (a pattern of predetermined first postures). The third control unit 180 handles a posture group including shrimp-like bending, backward bending, head side-toppling, side bending, and side toppling as a second posture group (a pattern of predetermined second postures). The second posture group is a set of postures at which a driver can monitor a forward view out of the first posture group.

The posture detecting unit 183 inputs an image of a driver captured by the second camera 70 to the model information 182. The posture detecting unit 183 acquires a posture index value as an output of the model information 182. The posture detecting unit 183 determines whether the posture of the driver corresponds to one posture in the first posture group by comparing the posture index with a threshold value for the first posture group. That is, the posture detecting unit 183 determines whether the detected posture matches one posture in the first posture group on the basis of the result of comparison.

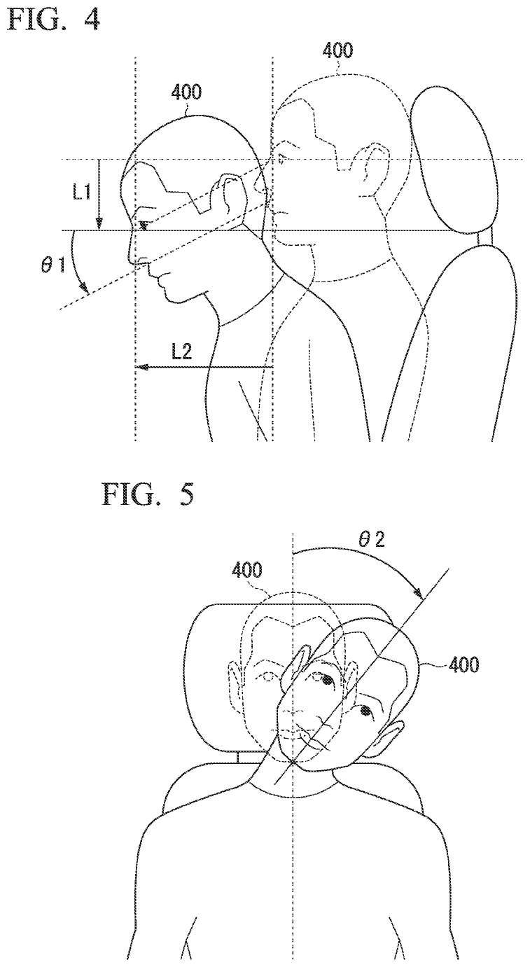

FIG. 4 is a diagram illustrating a first example of posture matching determination. In FIG. 4, a posture of a driver 400 who is prostrating is shown as an example of a posture. For example, the posture detecting unit 183 determines that the posture of the driver 400 matches a prostrating posture when the head of the driver 400 moves downward equal to or more than a threshold value “L1=180 mm” for two seconds or more, the head of the driver 400 moves forward equal to or more than a threshold value “L2=200 mm,” and the head of the driver 400 is inclined in a pitch direction (downward) equal to or more than a threshold value “θ1=30 degrees.”

FIG. 5 is a diagram illustrating a second example of posture matching determination. In FIG. 5, a posture of a driver 400 whose head is side-toppling is shown as an example of a posture. For example, the posture detecting unit 183 determines that the posture of the driver 400 matches a head side-toppling posture when the head of the driver 400 is inclined in a roll direction equal to or more than a threshold value “θ2=30 degrees” for two seconds or more.

The model information 182 may be prepared for each threshold value which is determined for a posture of a driver. For example, when the head of a driver is inclined in the roll direction by “30 degrees,” the model information 182 for a threshold value “30 degrees” generates a signal and thus the posture detecting unit 183 acquires a signal indicating that the head of the driver is inclined “30 degrees” in the roll direction from the model information 182 for the threshold value “30 degrees.” When the inclination in the roll direction of the head of the driver does not reach “45 degrees,” the model information 182 for the threshold value “45 degrees” does not generate a signal and thus the posture detecting unit 183 cannot acquire a signal indicating that the head of the driver is inclined “45 degrees” in the roll direction from the model information 182 for the threshold value “45 degrees.” The posture detecting unit 183 may determine whether the posture of the driver 400 matches one posture in the first posture group on the basis of such a signal.

The alarm processing unit 184 acquires vehicle situation information from the situation information acquiring unit 181. The alarm processing unit 184 acquires information of the detected posture from the posture detecting unit 183. When the posture detecting unit 183 determines that the detected posture matches one posture in the first posture group, the alarm processing unit 184 may perform the alarm process.

When posture destabilization occurs due to posture peculiarity of a driver, the alarm process is performed even though the driver is awake. Accordingly, the driver may feel discomfort from the alarm process. In this case, the driver may perform an operation of cancelling the alarm process. The cancelling operation is a predetermined operation and is, for example, an operation of re-depressing the accelerator pedal, a steering operation, or an operation of pressing a push button.

The posture detecting unit 183 determines whether the operation of cancelling the alarm process has been performed. The alarm processing unit 184 derives the number of times the operation of cancelling the alarm process has been performed by the driver as an occurrence frequency of a predetermined event for each posture. The predetermined event is an event in which the operation of cancelling the alarm process has been performed by the driver. The occurrence frequency may be an occurrence frequency of a predetermined event (the number of operations) in a predetermined time (for example, one driving period of time) or a time interval in occurrence of the predetermined event. When the detected situation does not match a specific situation or the detected posture does not match any posture in the second posture group, the posture detecting unit 183 may withhold derivation of the occurrence frequency of the predetermined event. The specific situation is, for example, a situation in which the vehicle speed is low (the vehicle speed is lower than a reference speed), a traffic volume is small (the traffic volume is less than a reference volume), and a road shape is not a crossing.

When the alarm process is not cancelled even if a predetermined period has elapsed after the alarm process has been performed, an abnormality in which the driver is not awake or the like is likely to occur and thus the second control unit 160 may switch a vehicle travel mode to an automated driving mode. For example, the second control unit 160 may decelerate the host vehicle on the basis of a target trajectory created by the movement plan creating unit 140 and move the host vehicle to a road side.

The vehicle system 1 may not include a function unit for automated driving as long as it includes the second camera 70, the third control unit 180, and the alarm device 300.

Alleviation process for making it difficult to determine that detected posture matches predetermined posture

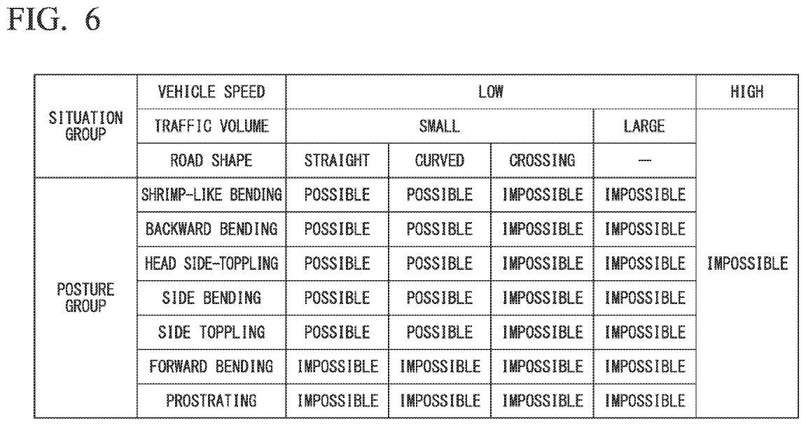

FIG. 6 is a diagram illustrating a data table indicating whether execution of the alarm process can be withheld for each combination of a situation and a posture. These data tables are stored in a storage device. In FIG. 6, a vehicle speed “high,” a vehicle speed “low,” a traffic volume “large,” a traffic volume “small,” a road shape “straight,” a road shape “curved,” and a road shape “crossing” are exemplified as a situation group. A criterion for determining that a traffic volume is large or small is, for example, a criterion of the number of other vehicles in a predetermined range from the host vehicle or a criterion of the number of pedestrians in a predetermined range from the host vehicle. For example, when the number of other vehicles in a predetermined range from the host vehicle is equal to or greater than a reference number (for example, two other vehicles), it is determined that the traffic volume is large. For example, when the number of pedestrians in a predetermined range from the host vehicle is equal to or greater than a reference number (for example, three persons), it may be determined that the traffic volume is large. A posture “shrimp-like bending,” a posture “backward bending,” a posture “head side-toppling,” a posture “side bending,” a posture “side toppling,” a posture “forward bending,” and a posture “prostrating” are exemplified as a posture group.

When an action of observing a situation such as a traffic volume near the vehicle (a driver's monitoring the surroundings) is relatively necessary or when the posture of the driver is not a posture in the second posture group (when the driver takes a posture with which the driver cannot monitor the front view), whether the posture of the driver is posture destabilization is determined with severity using a standard threshold value.

FIG. 6 illustrates whether execution of an alarm process can be withheld according to a combination of a situation and a posture. The posture detecting unit 183 acquires a standard threshold value. In a combination of a situation and a posture which is illustrated as “possible” or “impossible” in FIG. 6, the posture detecting unit 183 detects a posture using the standard threshold value in principle.

On the other hand, when a load of a driver's monitoring the surroundings is relatively light due to a small traffic volume near the vehicle or the like and a posture of the driver is a posture in the second posture group (when the driver takes a posture with which the driver cannot monitor the front view), whether the posture is posture destabilization may not be determined with severity. In other words, when a load of a driver's monitoring the surroundings is relatively light due to a small traffic volume near the vehicle or the like and a posture of the driver is a posture in the second posture group, whether the posture of the driver is posture destabilization may be determined using a threshold value which is less than the standard threshold value (hereinafter referred to as an “alleviation threshold value”). When whether the posture of the driver is posture destabilization is determined using the alleviation threshold value, execution of the alarm process is withheld.

In a combination of a situation and a posture illustrated as “possible” in FIG. 6, a load of a driver's monitoring the surroundings is relatively light due to a small traffic volume near the vehicle or the like and a posture of the driver is a posture in the second posture group. In the combination of a situation and a posture illustrated as “possible” in FIG. 6, the posture detecting unit 183 may detect a posture exceptionally using the alleviation threshold value.

When the detected situation matches a specific situation and the detected posture matches one posture in the second posture group, the alarm processing unit 184 determines whether an occurrence frequency of a predetermined event is equal to or greater than a reference frequency for the detected situation. When the occurrence frequency of the predetermined event is equal to or greater than the reference frequency, the posture detecting unit 183 acquires the alleviation threshold value such that it is not likely to determine that the detected posture matches one posture in the second posture group.

The alarm processing unit 184 may gradually alleviate the alleviation threshold value which is used by the posture detecting unit 183. For example, when the alarm process has been performed three times due to detection of the posture of head side-toppling and a driver has performed an operation of cancelling (releasing) the alarm process three times, the posture of head side-toppling may be peculiarity of the driver. Accordingly, the alarm processing unit 184 may alleviate a threshold value “30 degrees” for determining that it is the posture of head side-toppling to, for example, a threshold value “40 degrees.” When the alarm process has been additionally performed five times due to detection of the posture of head side-toppling and a driver has additionally performed the operation of cancelling (releasing) the alarm process five times, the alarm processing unit 184 may further alleviate the threshold value “40 degrees” for determining that it is the posture of head side-toppling to, for example, a threshold value “45 degrees.”

An occurrence frequency required until the alleviation threshold value is alleviated (changed) may differ depending on the posture. For example, the occurrence frequency required for alleviating the alleviation threshold value for determining a posture which cannot be easily determined may be set to be higher than the occurrence frequency required for alleviating the alleviation threshold value for determining a posture which can be easily determined. The posture which cannot be easily determined is, for example, forward bending.

Example of Operation of Third Control Unit 180

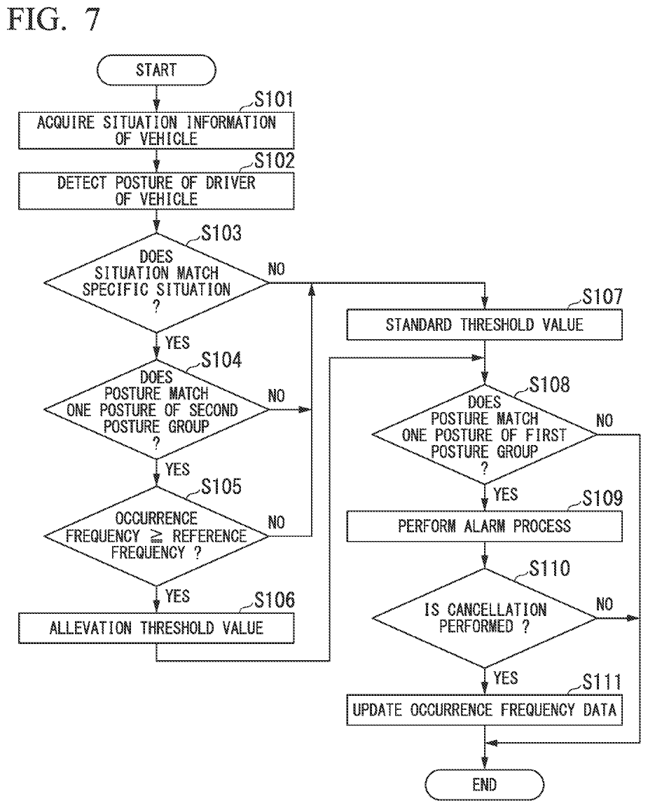

FIG. 7 is a flowchart illustrating an example of an operation of the third control unit 180. The routine illustrated in FIG. 7 is performed at intervals of a predetermined cycle. The situation information acquiring unit 181 acquires situation information of the vehicle from the object recognition device 16 and the vehicle sensor (Step S101). Then, the posture detecting unit 183 detects a posture of a driver of the vehicle on the basis of an image captured by the second camera 70 (Step S102). Then, the alarm processing unit 184 determines whether the detected situation matches a specific situation (a situation in which the vehicle speed is low, the traffic volume is small, and a road shape is not a crossing) (Step S103). Then, when the detected situation matches the specific situation, the alarm processing unit 184 determines whether the detected posture matches one posture in the second posture group (Step S104).

When the detected posture matches one posture in the second posture group, the alarm processing unit 184 determines whether an occurrence frequency of a predetermined event indicating that the alarm process was not valid in the past is equal to or greater than a reference frequency for the detected situation (Step S105). Then, when the occurrence frequency of the predetermined event is equal to or greater than the reference frequency, the posture detecting unit 183 acquires an alleviation threshold value. The acquired alleviation threshold value is stored in a storage device for each posture until it is updated (Step S106).

When the detected situation does not match the specific situation, when the detected posture does not match any posture in the second posture group, or when the occurrence frequency of the predetermined event is less than the reference frequency, the posture detecting unit 183 acquires a standard threshold value for each detected posture. For example, when the alleviation threshold value indicates an inclination of “45 degrees,” the standard threshold value indicates an inclination of “30 degrees.” The acquired standard threshold value is stored in the storage device for each posture until it is updated (Step S107).

Then, the posture detecting unit 183 determines whether the detected posture matches one posture in the first posture group using the standard threshold value. When the alleviation threshold value is acquired, the posture detecting unit 183 determines whether the detected posture matches one posture in the first posture group using the alleviation threshold value (Step S108).

When it is determined that the detected posture matches one posture in the first posture group, the alarm processing unit 184 performs the alarm process (Step S109). Then, the alarm processing unit 184 determines whether an operation of cancelling the alarm process has been performed. For example, the alarm processing unit 184 determines whether the accelerator pedal has depressed again by a driver (Step S110).

When the operation of cancelling the alarm process has been performed, the alarm processing unit 184 updates occurrence frequency data (operation number data) of the predetermined event indicating that the alarm process was not valid for the detected posture (Step S111). When it is determined that the detected posture does not match any posture in the first posture group, or when the operation of cancelling the alarm process has not been performed, the posture detecting unit 183 ends the routine illustrated in FIG. 7.

As described above, the situation information acquiring unit 181 acquires situation information of the vehicle from the object recognition device 16 and the vehicle sensor 40. The second camera 70 generates an image in which a driver of the vehicle appears. The posture detecting unit 183 acquires model information which has been trained by machine learning from the storage device. The posture detecting unit 183 detects a posture of the driver of the vehicle on the basis of the image captured by the second camera 70. When the detected posture matches one posture in the first posture group, the alarm processing unit 184 performs the alarm process of outputting information (for example, an alarm) from the alarm device 300. When the situation indicated by the situation information matches a specific situation and the detected posture matches one posture in the second posture group included in the first posture group, the alarm processing unit 184 withholds execution of the alarm process on the basis of an occurrence frequency of a predetermined event indicating that the alarm process was not valid. Accordingly, it is possible to perform the alarm process based on posture destabilization of the driver of the vehicle at an appropriate timing.

When a load of the driver's monitoring the surroundings is relatively light due to a small traffic volume near the vehicle or the like and the posture of the driver is one posture in the second posture group, the threshold value used to determine whether the posture is posture destabilization is alleviated and the posture is not easily determined to be posture destabilization. Accordingly, it is possible to perform the alarm process based on posture destabilization of the driver of the vehicle at an appropriate timing.

Since execution of the alarm process is withheld when posture destabilization occurs due to posture peculiarity of the driver and the alarm process is performed when posture destabilization occurs due to the driver not waking up, it is possible to reduce discomfort which is felt by the driver from the alarm process.

Hardware Configuration

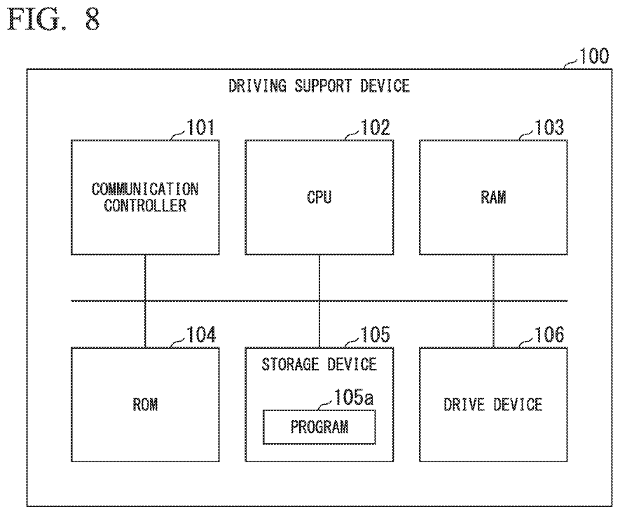

FIG. 8 is a diagram illustrating an example of a hardware configuration of the driving support device 100 (computer) according to the embodiment. As illustrated in the drawing, the driving support device 100 has a configuration in which a communication controller 101, a CPU 102, a random access memory (RAM) 103 used as a work memory, a read only memory (ROM) 104 storing a booting program, a storage device 105 such as a flash memory or a hard disk drive (HDD), a drive device 106, and the like are connected to each other via an internal bus or a dedicated communication line. The communication controller 101 communicates with elements other than the driving support device 100. A program 105a which is executed by the CPU 102 is stored in the storage device 105. The program is loaded to the RAM 103 by a direct memory access (DMA) controller (not illustrated) or the like and is executed by the CPU 102. As a result, some or all of the first control unit 120, the second control unit 160, and the third control unit 180 are realized.

The above-mentioned embodiment can be expressed as follows:

a driving support device including:

a storage device that stores a program; and

a hardware processor,

wherein the hardware processor is configured to execute the program stored in the storage device to realize:

a situation information acquiring unit configured to acquire situation information of a vehicle;

a posture detecting unit configured to detect a posture of a driver of the vehicle; and

an alarm processing unit configured to perform an alarm process of outputting information from an alarm device,

wherein the alarm processing unit is configured to:
perform the alarm process when the detected posture matches one posture of a first posture group; and
withhold execution of the alarm process on the basis of an occurrence frequency of a predetermined event indicating that the alarm process is not valid when a situation indicated by the situation information matches a specific situation and the detected posture matches one posture of a second posture group included in the first posture group.

While a mode for carrying out the present invention has been described above with reference to an embodiment, the present invention is not limited to the embodiment and can be embodied in various modifications and replacements without departing from the gist of the present invention.

What is claimed is:

1. A driving support device comprising:
a situation information acquiring unit configured to acquire situation information of a vehicle;
a posture detecting unit configured to detect a posture of a driver of the vehicle; and
an alarm processing unit configured to perform an alarm process of outputting information from an alarm device,
wherein the alarm processing unit is configured to:
perform the alarm process when the detected posture matches one posture of a first posture group; and
withhold execution of the alarm process on the basis of an occurrence frequency of a predetermined event indicating that the alarm process is not valid when a situation indicated by the situation information matches a specific situation and the detected posture matches one posture of a second posture group included in the first posture group.

2. The driving support device according to claim 1, wherein the specific situation is a situation in which a speed of the vehicle is less than a reference speed, a traffic volume near the vehicle is less than a reference volume, and a shape of a road on which the vehicle travels is not a crossing.

3. The driving support device according to claim 1, wherein the alarm processing unit is configured to derive the number of times the alarm process has been cancelled by the driver as an occurrence frequency of the predetermined event.

4. The driving support device according to claim 3, wherein the alarm processing unit is configured to withhold derivation of the occurrence frequency of the predetermined event when the detected situation does not match the specific situation or when the detected posture does not match any posture of the second posture group.

5. A driving support method that is performed by a computer of a driving support device, the driving support method comprising:
a situation information acquiring step of acquiring situation information of a vehicle;
a posture detecting step of detecting a posture of a driver of the vehicle; and
an alarm processing step of performing an alarm process of outputting information from an alarm device,
wherein the alarm processing step includes
performing the alarm process when the detected posture matches one posture of a first posture group; and
withholding execution of the alarm process on the basis of an occurrence frequency of a predetermined event indicating that the alarm process is not valid when a situation indicated by the situation information matches a specific situation and the detected posture matches one posture of a second posture group included in the first posture group.

6. A non-transitory computer-readable storage medium storing a program, the program causing a computer to perform:
a situation information acquiring process of acquiring situation information of a vehicle;
a posture detecting process of detecting a posture of a driver of the vehicle; and
an alarm processing process of performing an alarm process of outputting information from an alarm device,
wherein the alarm processing process includes
performing the alarm process when the detected posture matches one posture of a first posture group; and
withholding execution of the alarm process on the basis of an occurrence frequency of a predetermined event indicating that the alarm process is not valid when a situation indicated by the situation information matches a specific situation and the detected posture matches one posture of a second posture group included in the first posture group.
